(19) United States
(12) Patent Application Publication
(10) Pub. No.: US 2017/0278091 A1
(43) Pub. Date: Sep. 28, 2017

(54) TRANSACTION TRANSFER METHOD, TRANSACTION METHOD AND TERMINAL CARRYING OUT AT LEAST ONE OF SAID METHODS

(71) Applicant: ORANGE, Paris (FR)

(72) Inventors: Roberto Agro, Bourg La Reine (FR); Halim Bendiabdallah, Vaucresson (FR)

(21) Appl. No.: 15/466,789

(22) Filed: Mar. 22, 2017

(30) Foreign Application Priority Data
Mar. 24, 2016 (FR) 1652568

(51) Int. Cl. G06Q 20/32; G06K 7/14; G06K 19/06

(52) U.S. Cl. CPC G06Q 20/3276; G06K 19/06037; G06K 19/06112; G06K 7/1417

(57) ABSTRACT

The invention relates to a transaction transfer method, a transaction method and a terminal carrying out at least one of said methods.

One subject matter of the invention is a method for transferring transactions from a first communication terminal onto a second communication terminal, the transaction transfer method comprising a provision by a first terminal of an element relating to a transaction started on the first terminal intended for a second terminal, the second terminal performing a transaction as a function of said element.

A transaction may thus be started on a first terminal and ended on a second terminal, in particular for the purpose of securing the transaction.

The invention relates to a transaction transfer method, a transaction method and a terminal carrying out at least one of said methods.

Bank transactions linked to purchases on the Internet are widespread and represent an increasingly large volume. In order to prevent fraudulent transactions, banks are implementing increasingly sophisticated systems: AD Secure, virtual credit card number generation, etc.

In the case of the 3D Secure system, an Internet purchase from a terminal connected to any telecommunication network is secured by means of a validation from its mobile. The transaction is sent from the terminal from which the user makes the purchase to a transaction server which sends an SMS containing a code to a mobile telephone associated with the bank card of which the number has been entered for the transaction. This code will have to be entered by the user on the terminal in order to finalize the transaction.

This method enables authentication of the user of the bank card via his mobile telephone, but does not eliminate the risks of transactions via fraudulent sites (“fakes”) which pass themselves off as conventional merchant sites, for example a site “amazone.fr” which passes itself off as “amazon.fr”. The Secure 3D system does not protect the user from malicious software (“malware”) present in the terminal. In fact, the card number is entered on the machine and can be stolen. Moreover, the transaction passes through the Internet network and may be diverted.

Some organizations (banks, telecommunications operators, etc.) also propose the generation of a virtual card for a given sum. However, this mechanism requires a plurality of actions on the part of the user (connecting to his client space of the virtual card organization, entering the purchase sum, generating the virtual number and copying it on the transaction site, etc.), and does not avoid the risk of fraudulent merchant sites either. This method essentially prevents debits beyond the authorized amount or prevents a third party (for example by means of malware or a system for eavesdropping on the network) who obtains the card number during a desired transaction from being able to use it.

Another tendency for securing transactions is to rely on security mechanisms provided by telecommunications operators in order to make the stealing of the transaction of the IP frames of the transaction improbable or even impossible. Nevertheless, the terminals generally used for Internet purchases do not always allow access to the most secure networks, in particular to the mobile network. In fact, the purchaser generally prefers to browse through his catalogues and select his products on a larger screen than those of smartphones, and therefore carry out their transaction from a computer or from tablets connected to the Internet network, which pose the aforementioned security problems.

One of the objects of the present invention is to overcome shortcomings of the prior art.

One subject matter of the invention is a method for transferring transactions from a first communication terminal onto a second communication terminal, the transaction transfer method comprising a provision by a first terminal of an element relating to a transaction started on the first terminal intended for a second terminal, the second terminal performing a transaction as a function of said element.

A transaction may thus be started on a first terminal and ended on a second terminal, in particular for the purpose of securing the transaction.

The first terminal and the second terminal are advantageously connected to different telecommunications networks.

The transaction thus benefits from the additional security afforded by the communication network to which the second terminal is connected.

The first terminal is advantageously connected to an Internet network.

The transaction is thus started on a terminal offering greater convenience in the transaction selection phase: the Internet network offering fast catalogue loading and selection, and the terminals connected to this Internet network generally offering more user-friendly reproduction: larger screen, greater display precision, better sound (louder volume, more complex sound card, etc.).

The provision is advantageously a provision to a second terminal located a very short distance from the first terminal.

The risk of diversion of the transfer between the two terminals is thus limited.

The provision advantageously comprises a transmission of the element by the first terminal via a personal network.

Thus, not only is the transfer facilitated, since the terminals do not need to be physically connected, but also the risk of diversion of the transfer between the two terminals is limited, since the two terminals must be very close to one another.

The provision advantageously comprises a reproduction of the element by the first terminal in the form of a display of a QR code which makes up the element.

Thus, not only is the transfer facilitated since the terminals do not need to be physically connected, but also the risk of diversion of the transfer between the two terminals is zero, since the user of the first terminal chooses a second terminal which he allows to capture the QR code displayed by the first terminal.

The element advantageously comprises one or more of the following data:
transaction data, including at least one of the following transaction data:
   an address of the transaction server;
   a transaction sum;
   a transaction object;
   a transaction identifier;
   an identifier of a transaction recipient;
   an identifier of a transaction originator;
a link to one or more of the transaction data.

The transaction will thus end on the second terminal without the user needing to re-enter information that has already been entered on the first terminal.

One subject matter of the invention is also a transaction method on a second communication terminal, the transaction method comprising a reading of an element relating to a transaction started on a first communication terminal, the reading initiating a connection of the second terminal to a transaction server via a communication network as a function of the read element, the element having been supplied by the first terminal to the second terminal.

A transaction may thus be started on a first terminal and ended on a second terminal, particularly for the purpose of securing the transaction.

The second terminal is advantageously connected to a cellular telecommunication network.

The transaction thus benefits from the additional security afforded by the cellular communication network to which the second terminal is connected.

The reading advantageously comprises a reception of the element transmitted by the first terminal on a personal network.

Thus, not only is the transfer facilitated, since the terminals don't need to be physically connected, but also the risk of diversion of the transfer between the two terminals is limited since the two terminals must be very close to one another.

The reading advantageously comprises a capture of the element reproduced by the first terminal.

Thus, not only is the transfer facilitated, since the terminals do not need to be physically connected, but also the risk of diversion of the transfer between the two terminals is zero, since the user of the first terminal chooses a second terminal which he allows to capture the QR code displayed by the first terminal.

The transaction method advantageously comprises a connection of the second terminal to the transaction server via a telecommunication network as a function of the read element.

The transaction thus ends on the second terminal without the user needing to reconnect to the device managing the transaction to which he has connected by means of the first terminal.

The transaction method advantageously comprises an exchange of data between the second terminal and the transaction server authorizing a transaction as a function of the read element.

The instigator of the transaction is thus authenticated.

Advantageously, according to one implementation of the invention, the different steps of the method according to the invention are carried out by a computer program or software, this software including software instructions intended to be executed by a data processor of a device forming part of a communication terminal and being designed to control the performance of the different steps of this method.

The invention therefore also relates to a program including program code instructions for the performance of the steps of the transaction transfer method according to the invention and/or the steps of the transaction method according to the invention when the program is executed by a processor.

This program can use any programming language and can be in the form of source code, object code or code intermediate between source code and object code, such as in a partially compiled form or in any other desirable form.

One subject matter of the invention is also a communication terminal comprising at least one of the following devices:
a transaction transfer module providing an element relating to a transaction started on the terminal intended for another terminal, the other terminal performing a transaction as a function of said element;
a reader of the element relating to a transaction started on another communication terminal, the reader controlling a connection of the terminal to a transaction server via a communication network as a function of the read element, the element having been supplied by the other terminal to the communication terminal.

The characteristics and advantages of the invention will become clearer from a reading of the description, given by way of example, and the related figures, in which:

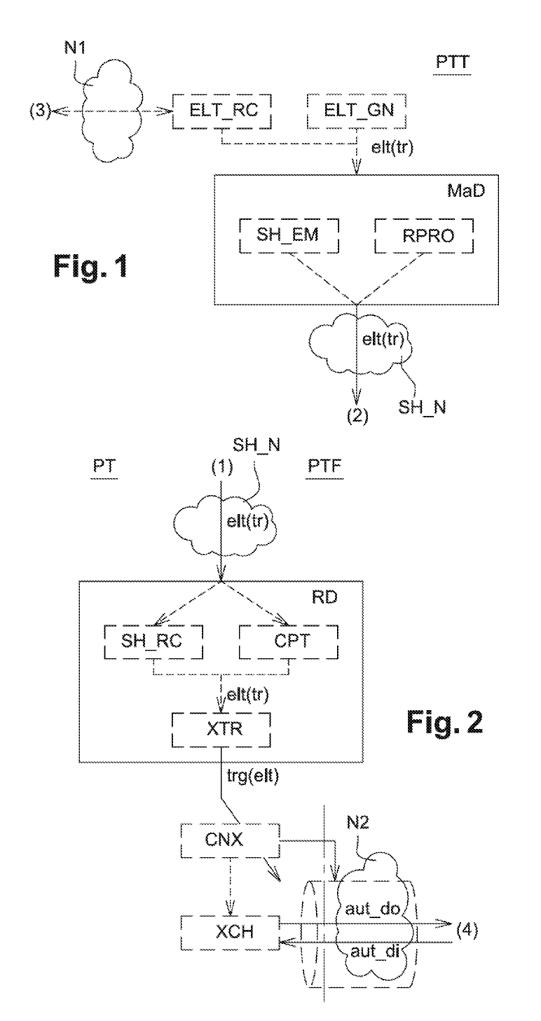

FIG. 1 shows a simplified diagram of a transaction transfer method according to the invention,

FIG. 2 shows a simplified diagram of a transaction method according to the invention,

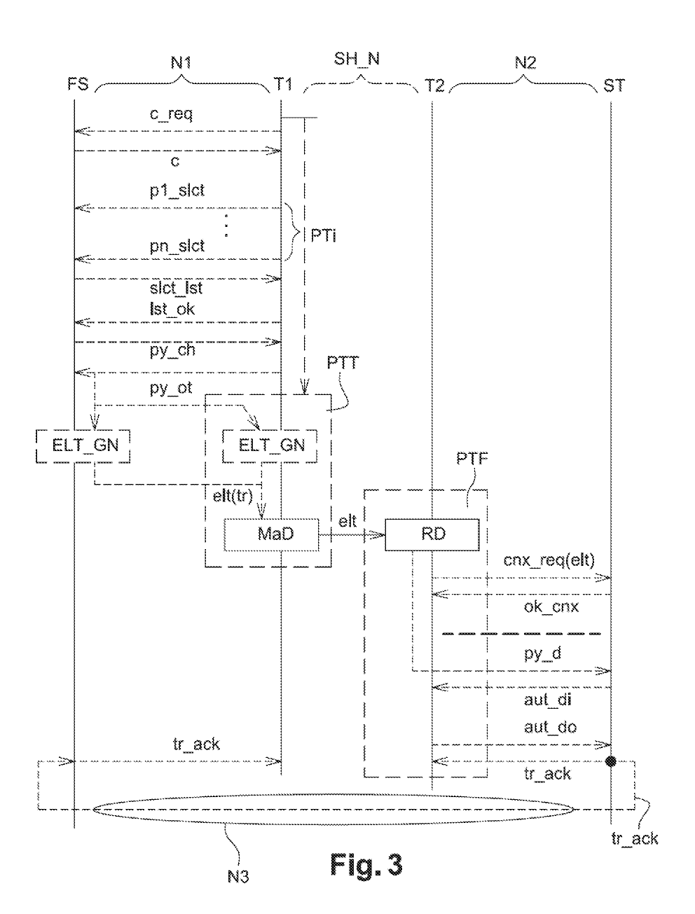

FIG. 3 shows a simplified diagram of exchanges between a first communication terminal, a second communication terminal according to the invention, a service-providing device, and a transaction server;

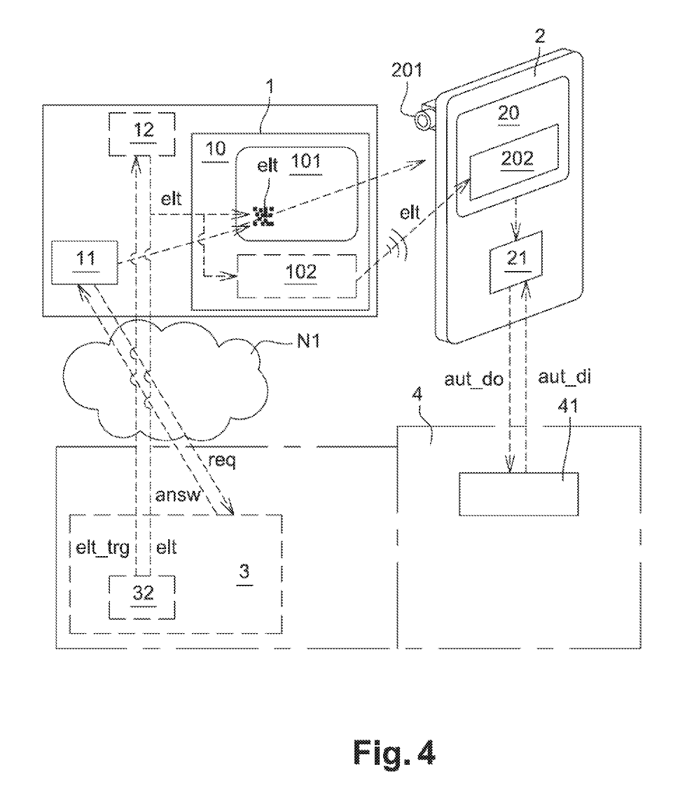

FIG. 4 shows a transaction system, comprising a first communication terminal and a second communication terminal according to the invention.

FIG. 1 shows a simplified diagram of a transaction transfer method according to the invention.

The transaction transfer method PTT allows the transfer of the transactions from a first communication terminal 1 onto a second communication terminal 2. The transaction transfer method PTT comprises a provision MaD by a first terminal 1 of an element elt relating to a transaction tr started on the first terminal 1 and intended for a second terminal 2, the second terminal 2 performing a transaction tr as a function of said element elt.

In particular, the first terminal 1 and the second terminal 2 are connected to different telecommunications networks N1 and N2.

In particular, the first terminal 1 is connected to an Internet network N1.

In particular, the provision MaD is a provision to a second terminal 2 located a very short distance from the first terminal 1.

In particular, the provision MaD comprises a transmission SH-EM of the element elt(tr) by the first terminal 1 via a personal network SH_N. The personal network is an individual wireless network referred to as WPAN (Wireless Personal Area Network). The personal network is a network having a short range in the region of a maximum of a few tens of meters. It enables a wireless link between two terminals (computer, tablets, smartphones, printers, television, domestic appliances, etc.) a very short distance apart. The personal network uses, in particular, one of the many currently available technologies such as Bluetooth, the technology referred to as HomeRF (Home Radio Frequency, a very short range radiofrequency technology), ZigBee, infrared, etc.

In particular, the provision MaD comprises a reproduction RPRO of the element elt(tr) by the first terminal 1 in the form of a display of a QR code which makes up the element elt.

In particular, the element elt comprises one or more of the following data:
transaction data, including at least one of the following transaction data:
   an address of the transaction server;
   a transaction sum;
   a transaction object;
   a transaction identifier;
   an identifier of a transaction recipient;
   an identifier of a transaction originator;
a link to one or more of the transaction data.

Transaction data is understood to mean any type of data relating to the transaction, including, in particular, those quoted above. A transaction object is understood, in particular, to mean a description or wording of the transaction. A transaction recipient is understood, in particular, to mean the merchant site receiving the sum of the transaction. The transaction originator is understood, in particular, to mean the customer of the merchant site purchasing a product or service on the merchant site and paying the sum of the transaction in exchange.

In particular, the transaction transfer method PTT comprises a generation of an element ELT_GN as a function of data relating to a transaction in progress on the first terminal 1, in particular as a function of one or more of the data listed above.

In particular, the generation of the element ELT-GN is performed by a service-providing device 3 with which the first terminal started the transaction. The reception of the element ELT_RC is then performed, in particular, by means of the transaction transfer method PTT via the network N1 to which the first communication terminal 1 is connected, originating from the service-providing device 3.

The generated element elt(tr) is then provided MaD by the transaction transfer method PTT to the second communication terminal 2.

In one particular embodiment, the transaction transfer method PTT is carried out in the form of a program including program code instructions for the performance of the steps of the transaction transfer method according to the invention when the program is executed by a processor.

FIG. 2 shows a simplified diagram of a transaction method according to the invention.

The transaction method PTF on a second communication terminal comprises a reading RD of an element elt relating to a transaction tr started on a first communication terminal 1. The reading RD initiates a connection CNX of the second terminal 2 to a transaction server 4 via a communication network N2 as a function of the read element elt. The element elt was supplied by the first terminal 1 to the second terminal 2.

In particular, the second terminal 2 is connected to a cellular telecommunication network N2.

In particular, the reading RD comprises a reception SH_RC of the element elt(tr) transmitted by the first terminal 1 on a personal network SH_N.

In particular, the reading RD comprises a capture CPT of the element elt(tr) reproduced by the first terminal 1.

In particular, the reading comprises an extractor XTR of data of the read element elt(tr) either through reception SH-RC on the personal network SH_N, or through capture CPT. The extractor XTR retrieves, either directly from the read element elt(tr) or indirectly, in particular via a request to a remote device via the communication network N2 data relating to the transaction, enabling control trg(elt), at least initially, of the establishment of the connection with the transaction server 4, such as, in particular, a transaction server 4 address and/or a link to a transaction server 4 address. The extraction also allows other data relating to the transaction to be retrieved, such as, in particular:
transaction data, including at least one of the following transaction data:
   a transaction sum;
   a transaction object;
   a transaction identifier;
   an identifier of a transaction recipient;
   an identifier of a transaction originator;
a link to one or more of the transaction data.

In particular, the transaction method PTF comprises a connection CNX of the second terminal 2 to the transaction server 4 via a telecommunication network N2 as a function of the read element elt(tr).

In particular, the transaction method PTF comprises an exchange of data XCH between the second terminal 2 and the transaction server 4 authorizing a transaction as a function of the read element elt(tr), in particular authorization data aut_do authorizing the transaction from the second terminal 2 to the transaction server 4 and/or authorization data aut_di authorizing the transaction from the transaction server 4 to the second terminal 2.

In one particular embodiment, the transaction method PTF is carried out in the form of a program including program code instructions for the performance of the steps of the transaction method according to the invention when the program is executed by a processor

FIG. 3 shows a simplified diagram of exchanges between a first communication terminal 1, a second communication terminal 2 according to the invention, a service-providing device 3 and a transaction server 4.

The first communication terminal T1, for example a computer, by means of an Internet browser, connects to a service-providing device FS, such as a merchant site, via a first communication network N1, in particular an Internet network. The first communication terminal T1 then carries out a transaction initialization method PTI. This transaction initialization method PTI comprises, in particular, at least some of the following steps until the transmission of a choice of payment method.

The connection of the first communication terminal T1 to the service-providing device FS allows the first terminal T1 to request access to the catalogue of the merchant site c_req. The service-providing device FS responds to this request by sending its catalogue c to the first communication terminal. The user of the first communication terminal T1, by means of a man-machine interface (not shown), thus makes a selection of products from the catalogue. The first terminal transmits each product selection from the catalogue p1_slct . . . pn_slct to the service-providing device. The service-providing device FS thus updates the list of selected products slct_lst and forwards it to the first terminal, either as soon as it has been updated, or only before finalizing the transaction. The first communication terminal T1 then forwards an approval of the list lst_ok before finalizing the transaction. The reception of the approval of the list of selected products lst_ok by the service-providing device FS initiates a payment method choice proposal py_md transmitted to the first communication terminal. The first communication terminal then transmits a chosen payment method to the service-providing device FS.

If the chosen payment method can be implemented from the first terminal (not shown), the service-providing device FS will connect the first communication terminal to a transaction server ST and the transaction will be finalized by the first communication terminal T1.

Our invention enables the proposal of a payment method to the first communication terminal from a second communication terminal T2, in particular for the purpose of securing the transaction. When the first communication terminal indicates such a choice of payment method m: py_ot, the first communication terminal carries out a transaction transfer method PTT. An element is generated ELT_GN, either by the service-providing device FS or by the first communication terminal, and is then made available MaD by the first communication terminal T1 to a second communication terminal close to it, in particular via a personal communication network SH_N or through reproduction, for example, of a QR code.

The second communication terminal T2 then carries out the transaction method PTF allowing the transaction started on the first communication terminal T1 to be finalized. To do this, the second communication terminal reads RD the element provided by the first communication terminal T1. Then, as a function of this element et, it requests the connection cn_req with the transaction server ST via the communication network N2 to which the second communication terminal T2 is connected. Once the connection has been established, in particular following acceptance of the connection ok_cnx by the transaction server ST, to the second communication terminal T2, the transaction data py_dt are received by the transaction server ST, either directly from the second terminal T2 which has, for example, extracted them from the read element elt or indirectly, the transaction server ST having retrieved from the second communication terminal the element read and transmitted to the service-providing device FS in order to retrieve the transaction data py_dt. Since the transaction server ST has all the data relating to the transaction, it exchanges data relating to the authentication of the transaction aut-di and aut_do with the second communication terminal, allowing the transaction server ST to authorize the transaction. When the transaction has ended, the transaction server ST sends a transaction acknowledgement tr_ack at least to the second communication terminal, or even via a communication network N3 to the service-providing device FS which will possibly transmit it to the first communication terminal T1. The two communication terminals involved in the transaction will thus have the information that the transaction has been completed.

FIG. 4 shows a transaction system comprising a first communication terminal and a second communication terminal according to the invention.

The first and/or second communication terminal 1, 2 comprises at least one of the following devices:
A transaction transfer module 10 providing an element elt relating to a transaction tr started on the terminal 1, 2 intended for another terminal 2, 1, the other terminal 2, 1 performing a transaction as a function of said element elt.
A reader 20 of the element elt relating to a transaction tr started on another communication terminal 2, 1, the reader 20 controlling a connection of the terminal 1, 2 to a transaction server 4 via a communication network N1, N2 as a function of the read element elt, the element elt having been supplied by the other terminal 2, 1 to the communication terminal.

In the example shown in our FIG. 4, a communication terminal 1, also referred to as the first terminal 1, comprises the transaction transfer module 10 providing an element elt relating to a transaction tr started on the terminal 1 intended for another terminal 2, the other terminal 2 performing a transaction as a function of said element elt.

In particular, the first terminal 1 comprises an access device 11, such as an Internet browser, for accessing a service-providing device 3 via a communication network N1 to which the first terminal 1 is connected. The access device 11 and the service-providing device 3 thus exchange req, ans in order to establish a transaction.

In particular, the service-providing device 3 or the first terminal 1 comprises a generator of an element relating to a transaction, 32, 12 respectively. Thus, when the first terminal 1 indicates req that it wishes to transfer the transaction to the service-providing device 3, the service-providing device controls the element generator 12 or 32 which supplies the generated element elt to the transaction transfer module 10.

In particular, the transaction transfer module comprises the element generator 12 of the first communication terminal 1.

In particular, the transaction transfer module 10 controls the reproduction by a screen 101 of the first communication terminal of the generated element to make it available to a second communication terminal, in particular in the form of a QR code as shown in FIG. 4.

In one alternative or additional embodiment, the transaction transfer module 10 controls the transmission, by a transmitter on the personal network 102 of the first communication terminal, of the generated element to provide it to a second communication terminal.

For example, on validation of a basket of goods selected by means of the first terminal 1 on the merchant site of a service-providing device 3, the service-providing device 3 controls the element generator 12, 22, in particular QR code generator, by supplying it with transaction data. Either the first communication terminal 1 or the service-providing device 3 or a third-party device (not shown) comprises this QR code generator. The element generator 12, 22 generates, in particular, a unique identifier of the transaction and, if necessary, encapsulates the data in a QR code reproduced by the first communication terminal 1 during the provision of the element elt. In particular, the element generator 22 supplies the element to the service-providing device FS which controls the provision thereof by the first terminal T1.

In the example shown in our FIG. 4, another communication terminal 2, also referred to as the second terminal 2, comprises the reader 20 of the element elt relating to a transaction tr started on the first communication terminal 1, the reader 20 controlling a connection of the second terminal 2 to a transaction server 4 via a communication network N2 as a function of the read element elt, the element elt having been supplied by the first terminal 1 to the second communication terminal 2.

In particular, the reader 20 controls the capture by a camera 201 of the second communication terminal 2 of the element reproduced by a first communication terminal 1, in particular in the form of a QR code, as shown in FIG. 4.

In particular, the element reader of the second terminal T2 comprises a QR code decoder in order to extract, in the aforementioned exemplary case, the unique transaction identifier. Furthermore, the second communication terminal may comprise a transaction device including the reader 20 (for example in the form of a processor implementing a transaction application). Either the transaction device knows the address of the transaction server and triggers the connection device 21, particularly in the case where the transaction device is specific to a telecommunication operator, or the transaction device interrogates a transaction server directory which supplies the address of a transaction server as a function of the number of the second communication terminal.

The transaction server 4 requires, in particular, an authentication from the second communication terminal 2, for example, the input of a PIN Code by the user of the second communication terminal 2. The authentication data are sent by the second communication terminal 2, in particular by its transaction device, to the transaction server 4, in particular to an authentication device of the transaction server 4.

In the event of a correspondence between an identifier of the originator of the transaction (user identifier, identifier of the second communication terminal) and the received authentication data (PIN Code, biometric data, etc.), the transaction device continues the transaction method, otherwise it controls the reproduction by at least the second terminal 2 of an error message indicating to it that the authentication has failed.

If the transaction continues, the transaction device of the second terminal 2 sends a request to the transaction server 4, supplying at least one datum relating to the transaction, such as a transaction identifier. The transaction server 4 comprises, in particular, a transaction manager (not shown) capable of retrieving the transaction details either from a database of the transaction manager fed, in particular, by the service-providing device 3 during the generation of the unique transaction identifier, or directly from the service-providing device 3. The transaction server 4, in particular the transaction manager, contacts, for example, a payment device by supplying the data relating to the paying account (bank card, SEPA credit transfer, etc., for example), and also the sum of the transaction which pays for the transaction. The transaction server 4, in particular the transaction manager, sends a notification to the transaction device of the second terminal 2, or even simultaneously to the service-providing device 3, indicating the success or failure of the transaction.

In another embodiment, the details of the transactions are encoded in the element instead of supplying only a transaction identifier. The transaction server 4 thus needs fewer exchanges, in particular with the transaction manager, in order to retrieve the transaction details, since the reader 20 supplies them to it.

The use of a unique transaction identifier enables a limitation of the data recorded in the element, thus enabling the use of a simpler element, such as a restricted-size QR code.

In particular, the second terminal 2 comprises a connection device 21 for connection to the transaction server 4 via a communication network N2 to which the second terminal 2 is connected. The connection device 21 and the transaction server 4 thus exchange aut_di, aut_do in order to authorize the transaction as a function of the read element. The transaction is, in particular, a payment by bank card, a payment on invoice from the communication terminal operator, etc.

In order to secure the transaction, the second communication terminal 2 is connected to a cellular network N2, such as a mobile communication network, in particular using one of the 2G, 3G, 4G, 5G, H+, Edge, etc., technologies. Since the transaction makes use of the cellular network, the transaction server 4 may comprise additional security mechanisms, such as a verifier of the country of the service-providing device 3. In fact, a bank or a merchant site could prohibit payments originating from specific countries. Furthermore, the country verification could also use the geolocation of the second communication terminal.

The bank card number is therefore not entered at any time on a sensitive terminal such as a communication terminal connected to an Internet network on which transaction diversion is easier. The transaction passes through a secure channel and avoids “phishing” or any fraudulent transaction technique. The cellular network operator plays the part of a trusted third party in relation to the user. In fact, the operator thus guarantees the authentication of the merchant site.

The invention also relates to a medium. The information medium may be any entity or device capable of storing the program. The medium may comprise, for example, a storage medium, such as a ROM, for example a CD-ROM or a microelectronic circuit ROM or else a magnetic recording medium, for example a floppy disk or hard disk.

Furthermore, the information medium may be a transmissible medium such as an electrical or optical signal which can be routed via an electrical or optical cable, via a radio link or via other means. The program according to the invention may, in particular, be downloaded from a network, in particular of Internet type.

Alternatively, the information medium may be an integrated circuit into which the program is incorporated, the circuit being suitable for executing or for being used in the execution of the method concerned.

In another implementation, the invention is implemented by means of software and/or hardware components. In this context, the term module may correspond equally well a software component or a hardware component. A software component corresponds to one or more computer programs, one or more subprograms of a program, or, more generally, to any element of a program or software capable of performing a function or a set of functions according to the description above. A hardware component corresponds to any element of a hardware assembly capable of performing a function or a set of functions.

1. Method for transferring transactions from a first communication terminal onto a second communication terminal, the transaction transfer method comprising a provision by a first terminal of an element relating to a transaction started on the first terminal intended for a second terminal, the second terminal performing a transaction as a function of said element.

2. Transaction transfer method according to claim 1, characterized in that the first terminal and the second terminal are connected to different telecommunications networks.

3. Transaction transfer method according to claim 1, characterized in that the first terminal is connected to an Internet network.

4. Transaction transfer method according to claim 1, characterized in that the provision is a provision to a second terminal located a very short distance from the first terminal.

5. Transaction transfer method according to claim 1, characterized in that the provision comprises a transmission of the element by the first terminal via a personal network.

6. Transaction transfer method according to claim 1, characterized in that the provision comprises a reproduction of the element by the first terminal in the form of a display of a QR code which makes up the element.

7. Transaction transfer method according to claim 1, characterized in that the element comprises one or more of the following data:
transaction data, including at least one of the following transaction data:
an address of the transaction server;
a transaction sum;
a transaction object;
a transaction identifier;
an identifier of a transaction recipient;
an identifier of a transaction originator;
a link to one or more of the transaction data.

8. Transaction method on a second terminal communication terminal, the transaction method comprising a reading of an element relating to a transaction started on a first communication terminal, the reading initiating a connection of the second terminal to a transaction server via a communication network as a function of the read element, the element having been supplied by the first terminal to the second terminal.

9. Transaction method according to claim 8, characterized in that the second terminal is connected to a cellular telecommunication network.

10. Transaction method according to claim 8, characterized in that the reading comprises a reception of the element transmitted by the first terminal on a personal network.

11. Transaction method according to claim 8, characterized in that the reading comprises a capture of the element reproduced by the first terminal.

12. Transaction method according to claim 8, characterized in that the transaction method comprises a connection of the second terminal to the transaction server via a telecommunication network as a function of the read element.

13. Transaction method according to claim 8, characterized in that the transaction method comprises an exchange of data between the second terminal and the transaction server authorizing a transaction as a function of the read element.

14. Program including program code instructions for performance of a transaction transfer method when the program is executed by a processor, the transaction transfer method for transferring transactions from a first communication terminal onto a second communication terminal, the transaction transfer method comprising a provision by a first terminal of an element relating to a transaction started on the first terminal intended for a second terminal, the second terminal performing a transaction as a function of said element.

15. Communication terminal comprising at least one of the following devices:
a transaction transfer module providing an element relating to a transaction started on the terminal intended for another terminal, the other terminal performing a transaction as a function of said element;
a reader of the element relating to a transaction started on another communication terminal, the reader controlling a connection of the terminal to a transaction server via a communication network as a function of the read element, the element having been supplied by the other terminal to the communication terminal.

16. Program including program code instructions for performance of a transaction method when the program is executed by a processor, the transaction method on a second terminal communication terminal, the transaction method comprising a reading of an element relating to a transaction started on a first communication terminal, the reading initiating a connection of the second terminal to a transaction server via a communication network as a function of the read element, the element having been supplied by the first terminal to the second terminal.
